(19) United States
(12) Patent Application Publication
(10) Pub. No.: US 2013/0035026 A1
(43) Pub. Date: Feb. 7, 2013

(54) Virtual convertible clip air streamer

(71) Applicant: Devane O'Neil Coke, Bridgeport, CT (US)

(72) Inventor: Devane O'Neil Coke, Bridgeport, CT (US)

(21) Appl. No.: 13/136,356

(22) Filed: Aug. 1, 2011

(51) Int. Cl. B60H 1/26

(52) U.S. Cl. 454/136; 454/69

(57) ABSTRACT

This invention “The Virtual Convertible Air Streamer” is a simple plastic vent (FIG. 1) that will take outside air from a vehicle (FIG. 2A) and cool humans inside (FIG. 2B) with no mechanics or mechanisms needed to propel the air. It is an original idea created by Devane O'neil Coke to help cool a passenger(s) traveling in hot or warm weather temperature. It will use moving air across skin to dissipate body heat. It will slightly protrude above roofs flush surface to catch a vehicles forward moving air flow (FIG. 2A) and direct it using a bend in the single vent (FIG. 1) that submerges into the cabin space of the vehicle to flow wind over passenger(s) skin (FIG. 2B) causing heat dissipation. It is a device for cooling human passengers of a vehicle with at least one plastic vent (FIG. 1) having a air intake side (FIG. 2A), and air outlet side (FIG. 2B), two magnets for securing to roof of vehicle (FIG. 4A and FIG. 4B), and two filtration meshes (FIG. 3A and FIG. 3B) to protect passenger from most objects, projectiles, and debris.

### CROSS-REFERENCE TO RELATED APPLICATIONS

| | | |
|---|---|---|
| 50266113 | June 1991 | DiCarlo , et al |
| 4039222 | August 1977 | Wolf et al. |
| 4220900 | September 1980 | Mntz |
| 4333680 | June 1982 | Wolf et al. |
| 4403805 | September 1983 | Strem, Jr. et al. |
| 4420184 | December 1983 | Kaltz |
| 4629953 | December 1986 | Inoue et al. |
| 4650243 | March 1987 | Hanley et al. |
| 4652045 | March 1987 | Hanley et al. |
| 4671565 | June 1987 | Grimm et al. |
| 4732422 | March 1988 | Schlapp et al. |
| 4746165 | May 1988 | Fuerst et al. |
| 4749227 | June 1988 | Bienert et al. |
| 4752099 | June 1988 | Roos et al. |

The cross referenced applications are in relation to this invention only as the created patented cavity of the roof called Sunroof in which the invention protrudes through to be able to direct outside air into cabin through.

### BACKGROUND OF THE INVENTION

1. Field of the Invention

Passengers traveling in vehicles that are equipped with sunroofs and moonroofs during hot and warm weather conditions usually have little or no dedicated or direct air flow from the roof cavity pointing directly to the body for dissipation of body heat. This invention is a vent that directs natural air that would normally pass over a vehicles aerodynamic shape into the sunroof or moonroof of a vehicle to let the naturally flowing cooler outside temperature air dissipate heat from the human body.

2. The invention will not use any mechanical function or propulsion what so ever. Only the natural movement of a forward moving motor vehicle will cause the air flow by displacement of the surrounding outside air.

3. The invention will be attached to the vehicles metal surface by outside magnets and is only to be used in safe and measured velocities of speed that is tested and advised for magnet strength.

4. The cross referenced applications relate to this invention only as the created patented cavity of the roof called Sunroof in which the invention protrudes through in order to be able to direct outside natural air into cabin through. Specifically referring to patents 50266113, U.S. Pat. Nos. 4,039,222, 4,220,900, 4,333,680, 4,403,805, 4,420,184, 4,629,953, 4,650,243, 4,652,045, 4,671,565, 4,732,422, 4,746,165, 4,752,099, 4,749,227. In no way is the mechanics or mechanisms of these patents used in aiding this invention to work. Only the open space and area in the roof of the vehicle of the referred patents are relating and beneficial to this invention.

### BRIEF SUMMARY OF THE INVENTION

The Virtual Convertible Clip Air streamer is a plastic vent that will be placed in a vehicles sunroof or moon-roof to direct air at a human passenger and dissipate heat from the body. Normally and currently, air would not flow into the vehicles cabin in a precise stream directed precisely at a passenger through a vent that is fixed and also attachable and detachable by magnets to the outside metal roof of a vehicle. It will use a single cavity vent with one bend to naturally capture air from the slip steam or air stream of car and direct it at the vehicle passenger.

### BRIEF DESCRIPTION OF THE SEVERAL VIEWS OF THE DRAWING

FIG. 1 Plain side view of Virtual Convertible Clip Air Streamer from right side with right magnet extending beneath

FIG. 2 Front left angle of Virtual Convertible Clip Air Streamer with slight view of front filtration mesh and left side magnet extending beneath

FIG. 2A Air directional for front of unit.

FIG. 2B Air directional for rear of unit.

FIG. 3A Direct view of bottom filtration mesh specifically pointed out with arrow and bottom-back angle view of Virtual Convertible Clip Air Streamer

FIG. 3B Direct view of front filtration mesh specifically pointed out with arrow and direct front angle view of Virtual Convertible Clip Air Streamer

FIG. 4 A Direct view from front-bottom angle of right magnet on direct bottom of Virtual Convertible Clip Air Streamer also accompanied by FIG. 4B

FIG. 4B Direct view from front-bottom angle of left magnet on direct bottom of Virtual Convertible Clip Air Streamer also accompanied by FIG. 4A

FIG. 5 General view and specification of all angles and dimensions of Virtual Convertible Clip Air Streamer

### DETAILED DESCRIPTION OF THE INVENTION

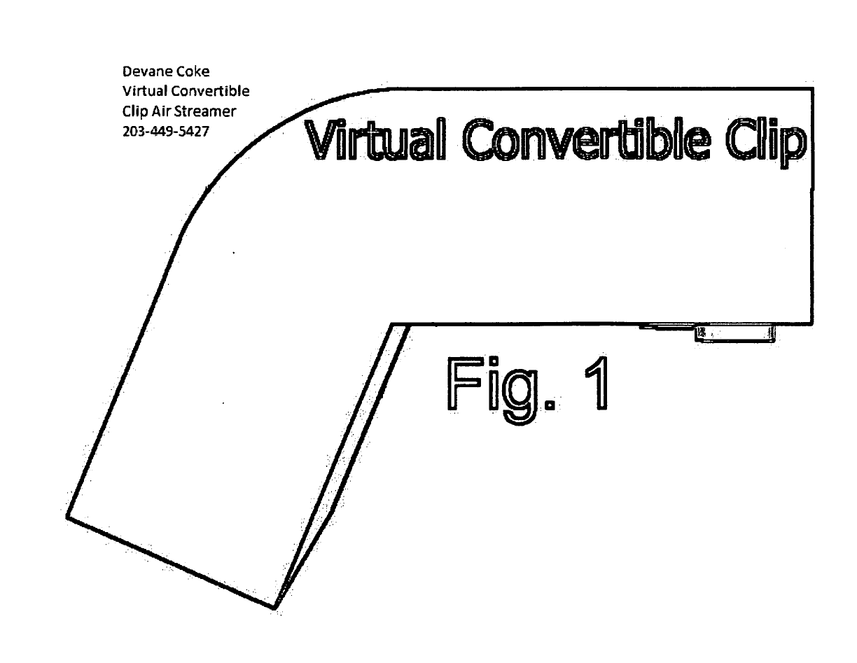

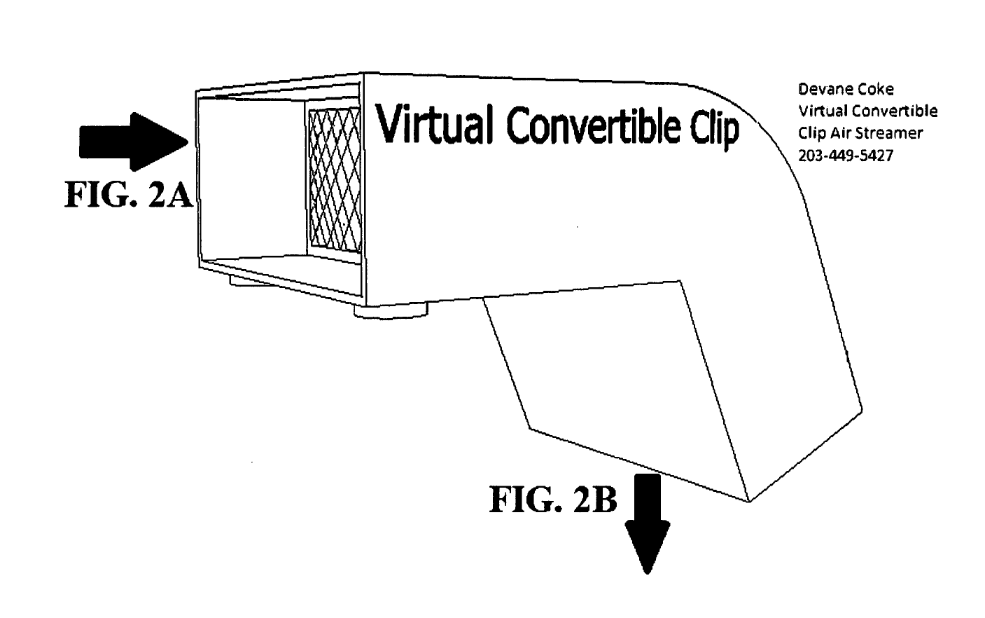

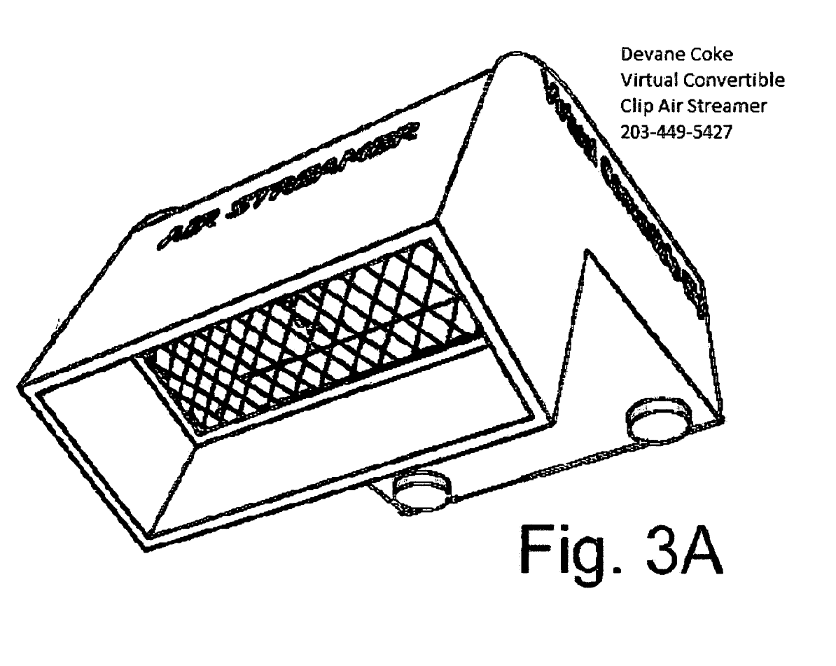

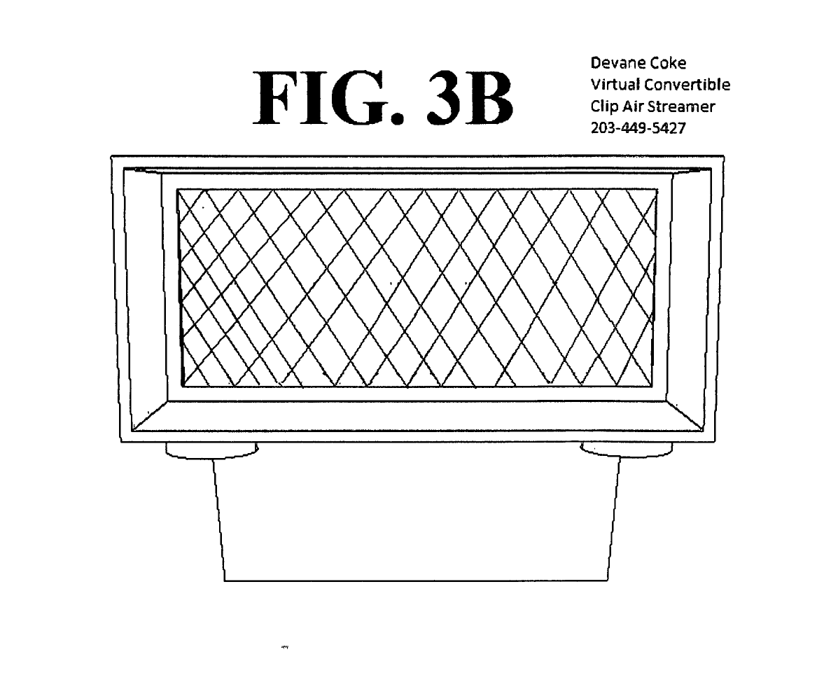

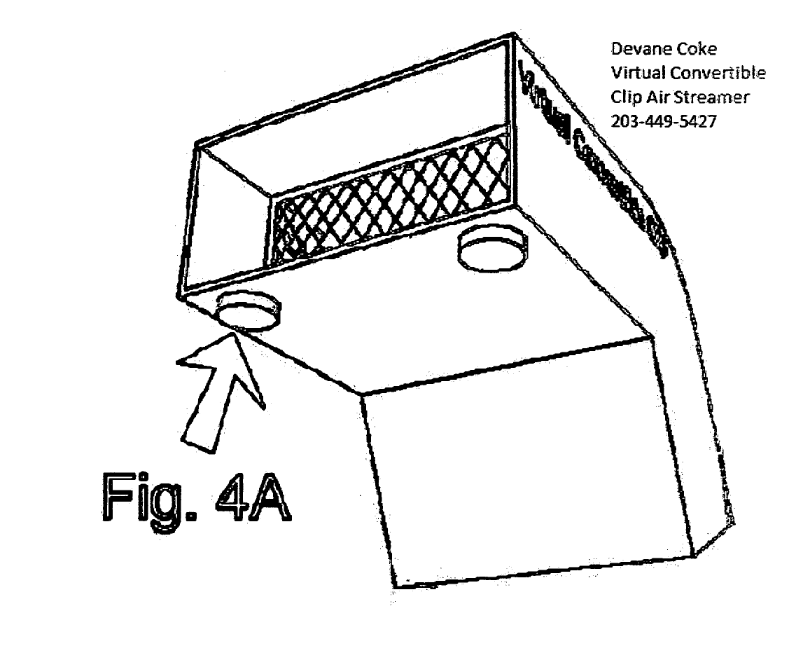

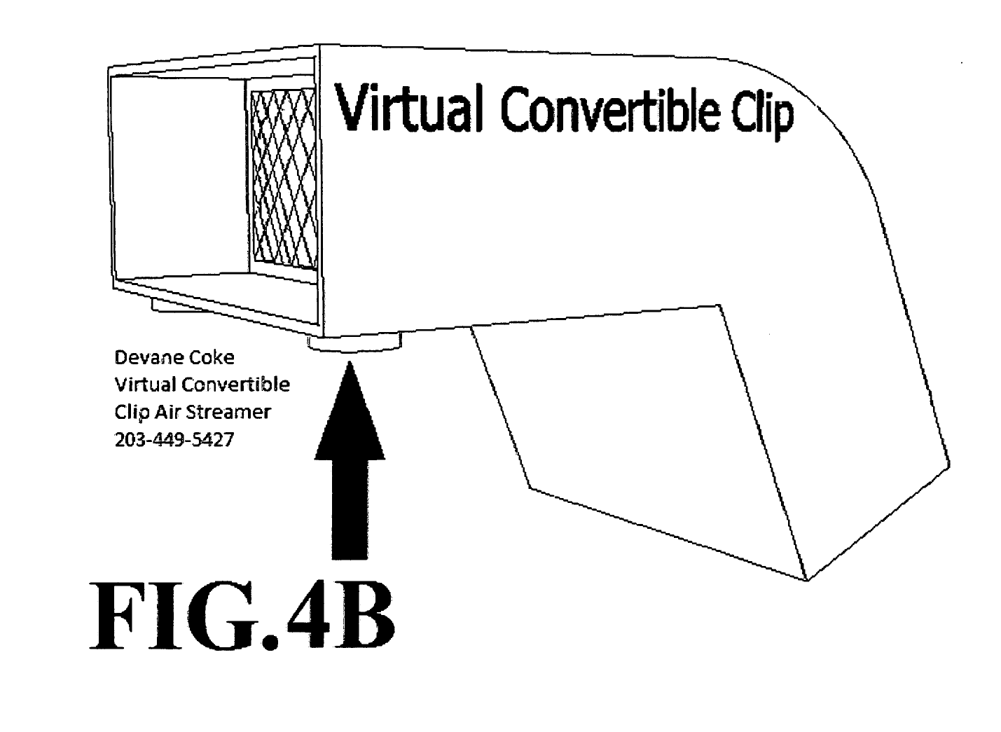

The invention is tilled the Virtual Convertible Clip Air Streamer. The invention will from here on forward be referred to as the Virtual Convertible Clip Air Streamer. This invention has no federally sponsored research/development. It is a single elbow vent made from generic ABS plastic (FIG. 1) that is used in conjunction with two magnets to stay fixed on top of a vehicles roof (FIG. 4A and FIG. 4B) and direct air from a vehicles natural air stream/slip stream (FIG. 2A) into the passenger cabin (FIG. 2B) to cool a passenger with natural wind. It stays fixed on top of a vehicle by two magnets that are on the left (FIG. 4B) and right side (FIG. 4A) of the inventions front. It will take in air from frontward vehicle movement (FIG. 2A) and bend the airflow to enter into the roofs cavity (FIG. 2B). The front portion of the vent will catch the air that is flowing over vehicles natural aerodynamic shape (FIG. 2A) and redirect it into the cabin (FIG. 2B) at the passenger(s) through the vents (L) design (FIG. 1) directly from the roof cavity. The Virtual Convertible Clip Air Streamer does not use any mechanical force to operate, only natural wind flow created by vehicles movement will be the sole basis of its proper and full function. The Virtual Convertible Clip Air Streamer is a single piece plastic cavity (FIG. 1A) that has two magnets (FIG. 4A and FIG. 4B) and two metal mesh screens (FIG. 3A and FIG. 3B) as separate pieces combined to make the entire completed unit. To build the Virtual Convertible Clip Air Streamer, a plastic injection or plastic molding machine must be used in conjunction with a corresponding metal casting mold of the shape or sections of shapes. The design of the tubed (L) vent (FIG. 1) cavity will be the cast that is filled with melted plastic and then cooled to its final shape. The body of the Virtual Convertible Clip Air Streamer will be ⅛th of an inch thickness all the way around and through. The Angle of the bend in unit is 123 degrees. The horizontal length of the (L) vent (FIG. 1) which runs parallel to roof runs 5% inches back from end of cavity which then goes into the 123 degree bend 3 inches to the vertical portion of (L) (FIG. 1) running perpendicular to the vehicles roof. The perpendicular to roof length of (L) vent which enters through roof cavity vertical is 4 inches. The total Height of Virtual Convertible Clip Air Streamer is 3 inches. The dimensions of the Virtual Convertible Clip Air Streamer cavity is 1¾×5¼ all the way around and all the way through. The mesh that filters objects, insects, debris, and projectiles out (FIG. 3A and FIG. 3B) will be inserted into the front (FIG. 3B) and rare (FIG. 3A) ends of the (L) tube (FIG. 1) (2 mesh screens.) The mesh inside horizontal top cavity (FIG. 3B) (mesh 1) starts 2 inches in from horizontal front edge of the Virtual Convertible Clip Air Streamer. The mesh inside vertical portion of (L) vent (FIG. 3A) cavity starts 2 inches in from bottom back edge of the Virtual Convertible Clip Air Streamer. The Magnets which are grade N-42 Neodymium earth magnets (FIG. 4A and FIG. 4B) measuring 28 mm in diameter and 5 mm in thickness will be placed on the bottom of invention that sits on top of the roof to hold Virtual Convertible Clip Air Streamer to vehicle with magnetic force “magnet hold to metal.” The magnets will be secured to the Virtual Convertible Clip Air Streamer by a single screw in each magnet which will start a half inch from front edge of Virtual Convertible Clip Air Streamer and also half inch from each side “left and right” of Virtual Convertible Clip Air Streamer.

### DESCRIPTION OF THE PREFERRED EMBODIMENT

It is a single elbow vent made from generic ABS plastic that is used in conjunction with two magnets to stay fixed on top of a vehicles roof and direct air from a vehicles natural air stream/slip stream into the passenger cabin to cool a passenger with natural wind. It stays fixed on top of a vehicle by two magnets that are on the left and right side of the inventions front. It will take in air from frontward vehicle movement and bend the airflow to enter into the roofs cavity. The front portion of the vent will catch the air that is flowing over vehicles natural aerodynamic shape and redirect it into the cabin at the passenger(s) through the vents (L) design directly from the roof cavity. The Virtual Convertible Clip Air Streamer does not use any mechanical force to operate, only natural wind flow created by vehicles movement will be the sole basis of its proper and full function. The Virtual Convertible Clip Air Streamer is a single piece plastic cavity that has two magnets and two metal mesh screens as separate pieces combined to make the entire completed unit. To build the Virtual Convertible Clip Air Streamer, a plastic injection or plastic molding machine must be used in conjunction with a corresponding metal casting mold of the shape or sections of shapes. The design of the tubed (L) vent cavity will be the cast that is filled with melted plastic and then cooled to its final shape. The body of the Virtual Convertible Clip Air Streamer will be ⅛th of an inch thickness all the way around and through. The Angle of the bend in unit is 123 degrees. The horizontal length of the (L) vent which runs parallel to roof runs 5% inches back from end of cavity which then goes into the 123 degree bend 3 inches to the vertical portion of (L) running perpendicular to the vehicles roof. The perpendicular to roof length of (L) vent which enters through roof cavity vertical is 4 inches. The total Height of Virtual Convertible Clip Air Streamer is 3 inches. The dimensions of the Virtual Convertible Clip Air Streamer cavity is 1%×5% all the way around and all the way through. The mesh that filters objects, insects, debris, and projectiles out will be inserted into the front and rare ends of the (L) tube (2 mesh screens.) The mesh inside horizontal top cavity (mesh 1) starts 2 inches in from horizontal front edge of the Virtual Convertible Clip Air Streamer. The mesh inside vertical portion of (L) vent cavity starts 2 inches in from bottom back edge of the Virtual Convertible Clip Air Streamer. The Magnets which are grade N-42 Neodymium earth magnets measuring 28 mm in diameter and 5 mm in thickness will be placed on the bottom of invention that sits on top of the roof to hold Virtual Convertible Clip Air Streamer to vehicle with magnetic force “magnet hold to metal.” The magnets will be secured to the Virtual Convertible Clip Air Streamer by a single screw in each magnet which will start a half inch from front edge of Virtual Convertible Clip Air Streamer and also half inch from each side “left and right” of Virtual Convertible Clip Air Streamer.

1. I claim to be the first inventor by the name of Devane O'neil Coke to create a vent that is used in conjunction with magnets and a single bend to non-mechanically redirect cooler flowing natural outside air into a vehicles cabin and direct it at the human passenger in the attempt to dissipate heat from the body.

2. I claim to be the first to use the existing sunroof and moon-roof of a vehicle with a separately attached device to aid and direct the flow of natural moving air in a vehicles slip stream and air stream at the vehicles human passenger(s).
